(19) United States
(12) Patent Application Publication
(10) Pub. No.: US 2008/0058076 A1
(43) Pub. Date: Mar. 6, 2008

(54) Gaming Machine and Gaming Method Thereof

(75) Inventor: Sakiko KOJIMA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORPORATION, Tokyo (JP)

(21) Appl. No.: 11/846,175

(22) Filed: Aug. 28, 2007

(30) Foreign Application Priority Data
Sep. 4, 2006 (JP) 2006-238760

(51) Int. Cl. G06F 17/00

(52) U.S. Cl. 463/20

(57) ABSTRACT

A gaming environment is described. Plural video reels are spin and stopped on plural window displays. If the number of scatter symbols repositioned on the plural window displays is a predetermined number, new video reel will be spin and stopped on new display window. After that, an award corresponding to a symbol repositioned on a payline on the new display window.

### CROSS-REFERENCE TO RELATED APPLICATIONS

This application is based upon and claims a priority from the prior Japanese Patent Application No. 2006-238760 filed on Sep. 4, 2006, the entire contents of which are incorporated herein by reference.

### BACKGROUND

1. Field

One or more aspects of the present invention relate to a gaming machine and gaming method thereof that provide an award based on repositioned symbols.

2. Description of Related Art

In some conventional gaming machines, if the number of repositioned symbols is predetermined number, an award is provided.

Above gaming machines, relations between the number of repositioned symbols and awards are determined beforehand in a payout table.

### SUMMARY

One or more aspects invention related to a gaming machine, a gaming method thereof, a computer readable medium having computer-executable instructions or the like which are nonconventional and provide new entertainment. Also, in one or more aspects of the present invention, plural video reels are spin and stopped on plural window displays. If the number of scatter symbols repositioned on the plural window displays is a predetermined number, new video reel will be spin and stopped on new display window. After that, an award corresponding to a symbol repositioned on a payline on the new display window. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a view showing a feature of a slot machine in accordance with one or more aspects of the present invention.

FIG. 2 is a perspective view showing the slot machine in accordance with one or more aspects of the present invention.

FIG. 3 is a view schematically showing the symbols displayed on the virtual outer surface of each video reel in accordance with one or more aspects of the present invention.

FIG. 4 is a view schematically showing symbol row displayed on the virtual outer surface of each video reel (which is winning reel) in accordance with one or more aspects of the present invention.

FIG. 5 is a block schematically diagram of a control system of the slot machine in accordance with one or more aspects of the present invention.

FIG. 6 is a view showing a payout table which indicates the winning combination, the probability thereof, and the payout number thereof, in the game in accordance with one or more aspects of the present invention.

FIG. 7 is a view showing a combination table which indicates a combination to be any-payout in the base game in accordance with one or more aspects of the present invention.

FIG. 8 is a view showing a sample contents displayed on the lower image panel 6.

FIG. 9 is a view showing a sample contents displayed on the lower image panel 6.

FIG. 10 is a flowchart of a main control process program in accordance with one or more aspects of the present invention.

FIG. 11 is a flowchart of a main game process program in accordance with one or more aspects of the present invention.

FIG. 12 is a flowchart of a base game lottery process program in accordance with one or more aspects of the present invention.

FIG. 13 is a flowchart of a symbol display control process program in accordance with one or more aspects of the present invention.

FIG. 14 is a view showing a feature of the slot machine in accordance with one or more aspects of the present invention.

FIG. 15 is a flowchart of the symbol display control process program in accordance with one or more aspects of the present invention.

FIG. 16 is a view showing a first winning reel and “WIN” symbols in accordance with one or more aspects of the present invention.

FIG. 17 is a view showing a sample contents displayed on the lower image panel 6.

FIG. 18 is a flowchart of the main game process in accordance with one or more aspects of the present invention.

FIG. 19 is a flowchart of the base game lottery process in accordance with one or more aspects of the present invention.

FIG. 20 is a view showing a bonus reel and “WIN” symbols in accordance with one or more aspects of the present invention.

FIG. 21 is a flowchart of the main game process in accordance with one or more aspects of the present invention.

FIG. 22 is a flowchart of the bonus game process in accordance with one or more aspects of the present invention.

### DETAILED DESCRIPTION

The various aspects summarized previously may be embodied in various forms. The following description shows by way of illustration of various combinations and configurations in which the aspects may be practiced.

It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to one or more aspects of the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk.

Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU” and “processor” are inclusive by nature, including at least one of hardware, software, or firmware.

These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

An embodiment embodying one or more aspects of the invention as a slot machine will be described in detail with reference to the drawings below.

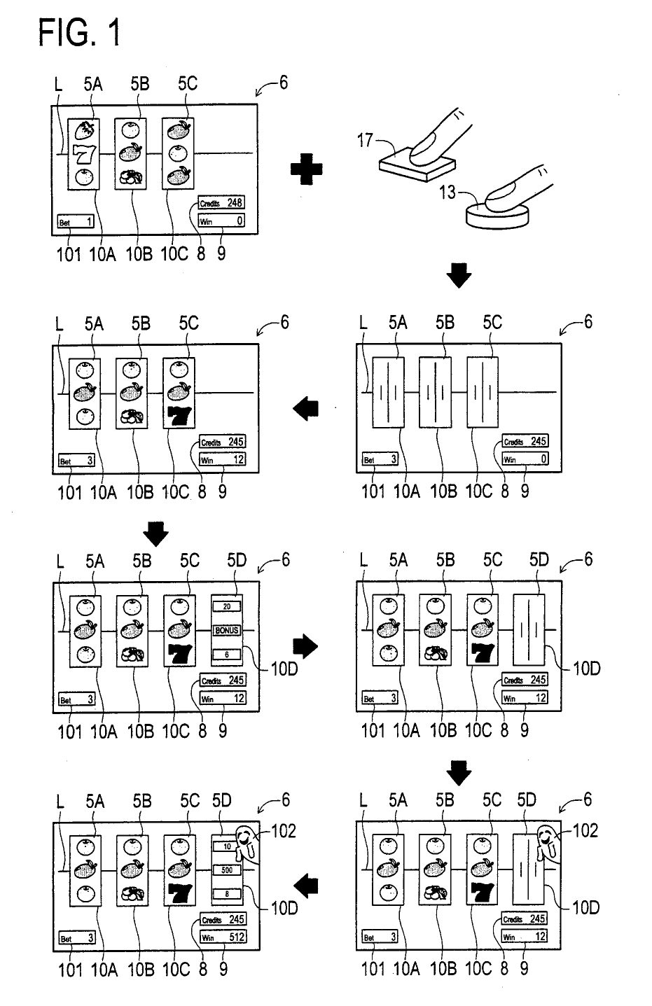

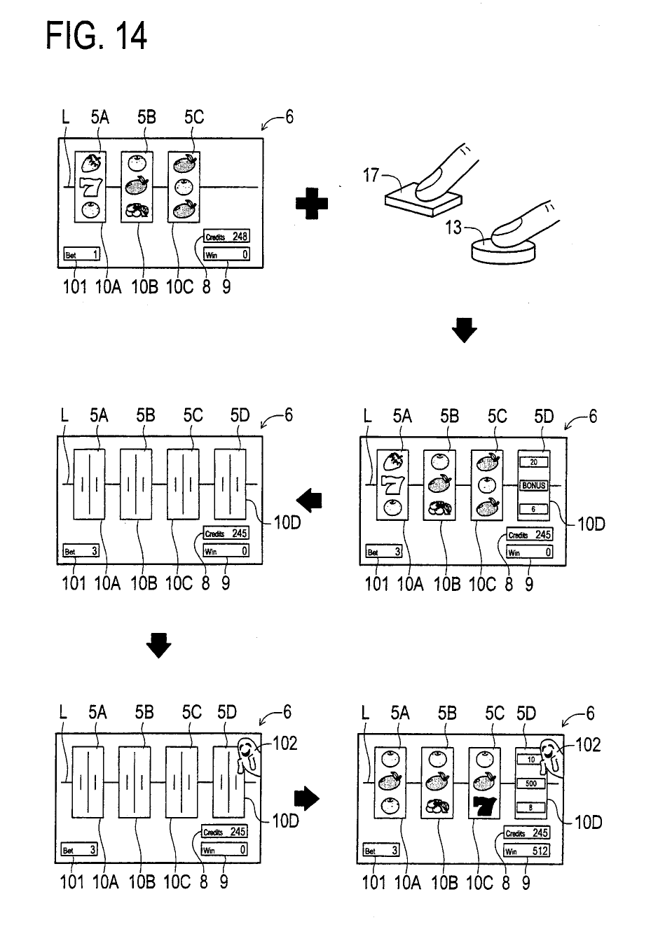

FIG. 1 shows a feature of a slot machine of the embodiment of one or more aspects of the present invention. Here, lower display panels 6 of FIG. 1 are specified with the use of the number of columns from the top. FIG. 14 which will be later is the same as that. In the slot machine of the embodiment, as shown in left-first column of FIG. 1, three visible display windows 10A, 10B, and 10C are displayed and each of three symbols displayed on virtual outer surfaces of each video reel 5A, 5B, and 5C are arranged on the window displays 10A, 10B, and 10C respectively. One payline is displayed on the lower image display panel 6. The payline horizontally crosses three display windows 10A, 10B, and 10C. The payline L sets a combination of the symbols. A bet count display portion 101, a credit count display portion 8, and a payout number display portion 9 are displayed on the lower image display panel 6. Various winning combinations are set beforehand based on the combinations of each symbol.

As shown in right-first column of FIG. 1, if a player operates a spin button 13, each of the video reels 5A, 5B, and 5C are spun as shown in right-second column of FIG. 1. When a predetermined time is elapsed, for example, as shown in left-second column of FIG. 1, each of the video reels 5A, 5B, and 5C will be stopped and each of three symbols are re-arranged on each of the display windows 10A, 10B, and 10C respectively. Here, the combination of the symbols re-arranged on the payline L is any of the winning combinations, an award corresponding to the combination will be provided to the player.

If four or five symbols of “ORANGE”, which is a scatter symbol, are arranged on each of the display windows 10A, 10B, and 10C, a payout number will be provided or a bonus game will be executed as any-payout regardless of whether or not the symbol of “ORANGE” is re-arranged on the payline L.

In this case, in the lower image display panel 6, after each of the video reel 5A, 5B, and 5C are stopped, a video reel 5D will be spun and stopped. That is, if four or five symbols are “ORANGE” among nine symbols re-arranged on the each of the display windows 10A, 10B, and 10C, as shown in left-third column of FIG. 1, one new visible display window 10D will be displayed on the right side of the display window 10C, and three symbols displayed on virtual outer surface of the window display 10D are re-arranged via the window display 10D. Here, on the virtual outer surface of the video reel 5D, twenty-two symbols including numbers indicating the payout numbers and “BONUS” which indicates the bonus game.

As shown in right-third column and both sides of fourth column of FIG. 1, on the window display 10D of the lower image display panel 6, the video reel 5D is spun and stopped and three symbols are re-arranged on the display window 10D. Here, if symbol displayed on the payline L on the display window 10D is number, the payout number indicated by the displayed number will be provided to the player. If the symbol displayed on the payline L on the display window 10D is “BONUS”, the bonus game will be executed. Concretely, in left-fourth of FIG. 1, the symbols displayed on the payline L on the display window 10D is number of “500”, so the payout number of “500” will be provided to the player.

Here, if “500” or “BONUS” are re-arranged on the payline L on the display window 10D after the video reel 5D is spun and stopped, as shown in both sides of fourth column of FIG. 1, an image effect in which a character stops spinning video reel 5D is conducted on the lower image display panel 6.

Here, the video reel 5D to be spun and stopped is changed based on the bet count which is set by the user with the use of the spin button 13. That is, the video reel 5D includes a first winning reel and a second winning reel. If maximum bet count is set, the second winning reel may be selected and the second winning reel may be spun and stopped. On the other hand, other than maximum bet count is set, the first winning reel will be selected and the first winning reel will be spun and stopped. Concretely, in right-first column of FIG. 1, the player operates a maximum button 17 and maximum bet count is set, so as shown in third column and fourth column of FIG. 1, the second winning reel is spun and stopped in the display window 10D.

Here, each of the number displayed on the virtual outer surface of the second winning reel is twice as high as each of the number displayed on the virtual outer surface of the first winning reel. That is, if the player sets the maximum bet count, higher payout number will be provided as the any-payout compared to other than maximum bet count set by the player.

The embodiment embodying one or more aspects of the invention as the slot machine will be described in detail with the reference drawings below.

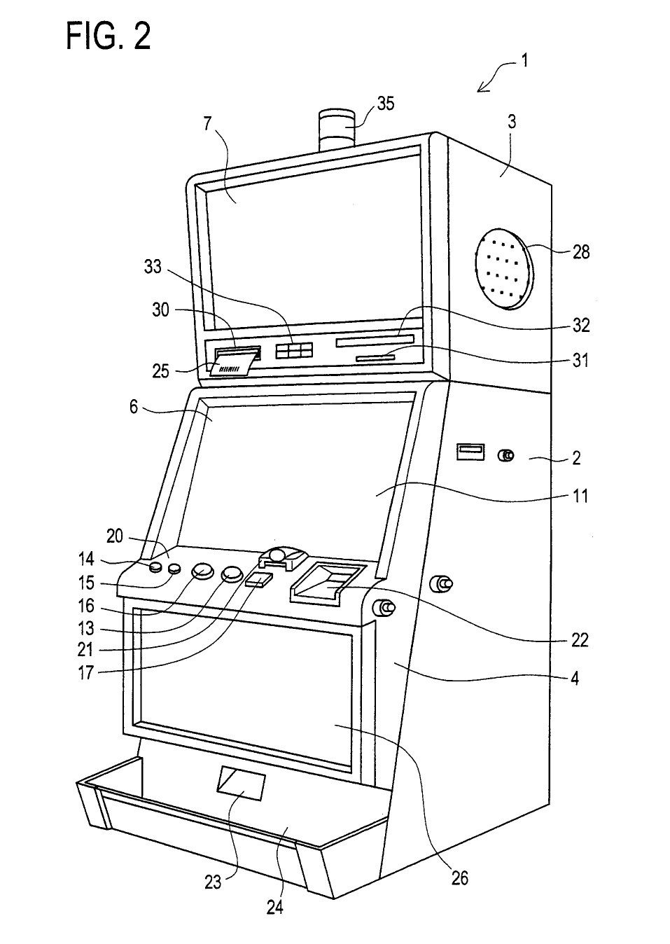

At first, a construction of the slot machine 1 of the embodiment embodying one or more aspects of the invention will be described with reference to FIGS. 2. FIG. 2 is a perspective view showing the slot machine of the embodiment.

The slot machine 1 may include a cabinet 2, a top box 3, and a main door 4. The top box 3 is arranged on the cabinet 2 (for instance, arranged on upper side). The main door 4 is arranged at front of the cabinet 2.

An upper image display panel 7 may be arranged with the slot machine 1 (for example, arranged in front of the top box 3). The upper image display panel 7 may include the display device (for example, LCD panel). Gaming information such as demonstration image, the game rule, the payout table, or the like may be displayed on the upper image display panel 7.

A lower image display panel 6 may be arranged with the slot machine 1 (for example, arranged in front of the main door 4).

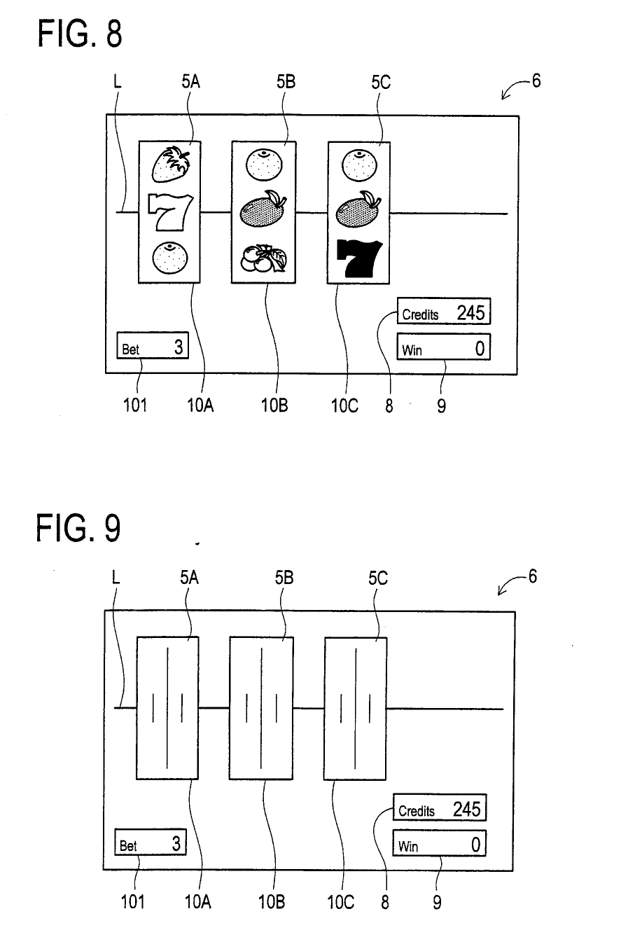

Images of the game in the slot machine 1 displayed on the lower image display panel 6 will be described. FIG. 8 and 9 are sample contents displayed on the lower image panel 6. In the based game, as shown in FIG. 8 and 9, the symbols displayed on the virtual outer surface of the each video reel 5A, 5B, and 5C are visible on the each display window 10A, 10B, and 10C on the lower image display panel 6. FIG. 8 shows a condition that the symbols displayed on the virtual outer surface of each video reel 5A, 5B, and 5C are arranged or re-arranged. FIG. 9 shows a condition that the symbols display on the virtual out surface of each video reel 5A, 5B, and 5C are spin.

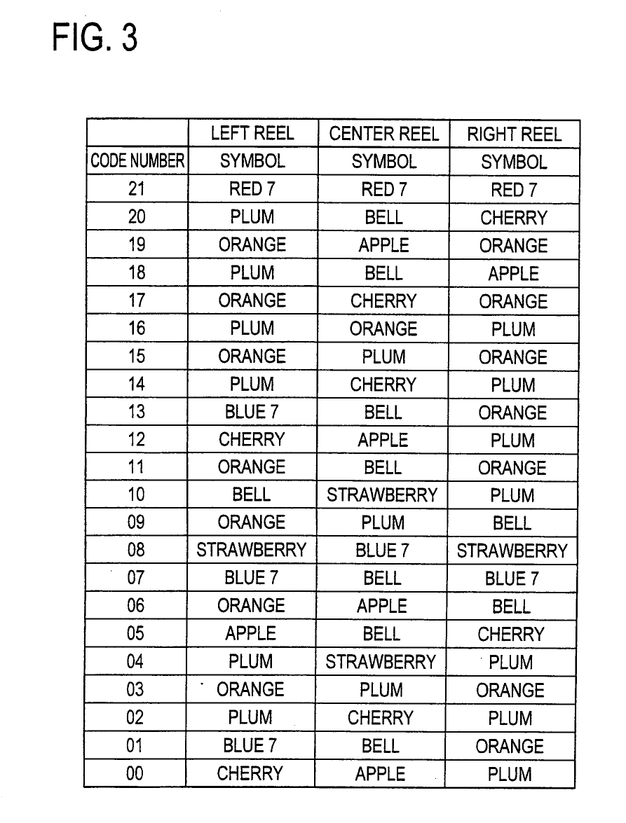

Here, symbols rows (see FIG. 3) composed of twenty-two symbols are displayed on the virtual outer surface of three video reels 5A, 5B, and 5C.

The bet count display portion 101, the credit count display portion 8, and the payout number display portion 9 are arranged on the lower image display panel 6. The bet count in which the player currently bets may be displayed on the bet count display portion 101. The credit count in which the player currently owns may be displayed on the credit count display portion 8. The payout number to be provided when a combination of stopped and displayed symbols on payline(s) L is any of predetermined combinations, the payout number to be provided as the any-payout, or the payout number to be provided in the bonus game, may be displayed on the payout number display portion 9.

On the lower image display panel 6, three visible display windows 10A, 10B, and 10C are displayed, and each three symbols displayed on virtual outer surface of each video reel 5A, 5B, and 5C are arranged on each display window 10A, 10B, and 10C respectively.

As shown in FIG. 8 and 9, one payline L may cross three display windows 10A, 10B, and 10C on the lower image display panel 6. The payline L may set the combination of the symbols.

Here, if four or five symbols of “ORANGE” is repositioned on each of the display windows 10A, 10B, and 10C regardless of whether or not the symbols are repositioned on the payline, the any-payout will be provided.

In the bonus game, each display window 10A, 10B, 10C, and 10D (including each video reel 5A, 5B, 5C, and 5D), the payline L, and the bet count display portion 101 are erased, and predetermined bonus screen may be displayed in addition to the credit count display portion 8 and the payout number display portion 9.

Returning FIG. 2, a control panel 20 is arranged at the image display panel 6 (for example, arranged on lower side). Buttons are arranged at the control panel 20. The buttons are the buttons to input the instructions for gaming session by the player. A coin insertion slot 9 and a bill verifier 22 can be arranged in relation to the image display panel 6 (for example, arranged on lower side). The coin insertion slot 21 may receive the gaming medium into the cabinet 2.

A spin button 13, a change button 14, a cash out button 15, a 1-bet button, and a max-bet button 17 are arranged on the control panel 20. The spin button 13 can be used when the instruction for the start for the video reels 5A, 5B, and 5C spin is input. Here, a physical lever may be used as substitute for the spin button 13. Also, the physical lever may be used in conjunction with the spin button 13. The change button 14 is used when the exchange is required. The cash out button 15 is the instruction for the payment of the coin (for example, one credit is equal to one coin) or for the print a ticket 25. One or more bar codes may be printed in the ticket 25. The ticket 25 may be called GAMING VOUCHER. The coin may be paid through a coin payout opening 23 to a coin tray 24. Here, other than bar code may be used as substitute for the bar code (for example, QR Code (two-dimensional bar code)).

The 1-bet button 16 is used when the instruction for the bet to one credit from the player's credits. The max-bet button 17 is used when the instruction for the bet to available maximum bet count in one game (for example, three credits) from the credits which is owned by the player is input.

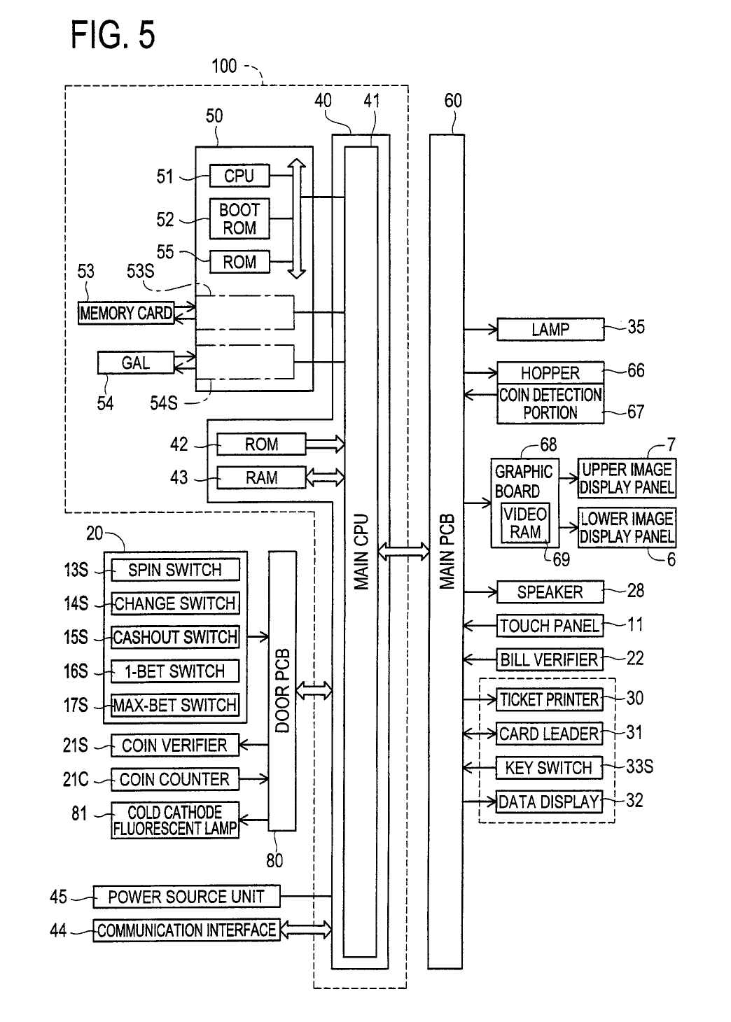

A coin verifier 21S (see FIG. 5) and a coin counter 21C (see FIG. 5) are arranged inside of the coin slot 21. The coin verifier 21S (see FIG. 5) verifies the coin inserted from the coin insertion slot 21, and the fake coins may be discharged through the coin payout opening 23. The coin counter 21C detects qualified coin and counts the number of the coins.

The bill verifier 22 verifies the bill and receives qualified bill into cabinet 2. The bill which is received into cabinet 2 is converted to the coin count, and the credit count corresponding to the converted coin count may be added to the owned credit count of the player. The bill verifier 22 can read a ticket 25 (which will be described later). A panel 26 is arranged on the main door 4 (for example, arranged on lower side, namely arranged below the control panel 20). Characters of the slot machine 1 may be displayed on the panel 26.

In the slot machine 1 of the embodiment, the gaming medium may be coin, bill, or electronic value (credit). Here, the gaming medium may be other things as well (including but not limited to medal, token, electronic money, or ticket).

A ticket printer 30, a card reader 31, a data display 32, and a keypad 33 are arranged at the upper image display panel 7 (for example, arranged on lower side).

The ticket printer 30 prints the ticket with the bar code in which the data (such as credit count, date, or ID number of the slot machine 1) may be coded. The printed ticket is the ticket 25. When the ticket 25 is scanned by other gaming machines, the player will be able to play the other gaming machines or be able to go through some procedure in some place.

The card reader 31 reads from the storage medium (for example, smart card) and writes the storage medium (for example, smart card). The player owns the storage medium, and the gaming record of the player is stored in the storage medium.

The data (which is read by the card reader 31 or input data which is input by the player via the keypad 33) may be displayed on the data display 32. The keypad 33 may be used when the player input the instruction or the data related to the print the ticket (for example). A lamp 35 is arranged at the top box 3 (for example, arranged on top). The lamp 35 may turn on with predetermined pattern when the player wants call the clerk of the game hall when the slot machine 1 has errors (for example).

Here, loudspeaker 28 may be arranged.

The symbols will be described with reference to FIG. 3. The symbols are displayed on the virtual outer surface of the each video reel 5A, 5B, and 5C, and repositioned with scroll via the each display window 10A, 10B, and 10C of the lower image display panel 6 in the game. FIG. 3 is a view schematically showing the symbols displayed on the virtual outer surface of each video reel 5A, 5B, and 5C.

On the virtual outer surface of the left video reel 5A, the center video reel 5B, and the right video reel 5C, twenty-two symbols may be displayed. Here, each of symbol rows may include the symbols of “RED7”, “BLUE7”, “BELL”, “APPLE”, “STRAWBERRY”, “PLUM”, “CHERRY”, and “ORANGE”. As shown in FIG. 3, symbols are positioned on the virtual outer surface in predetermined order.

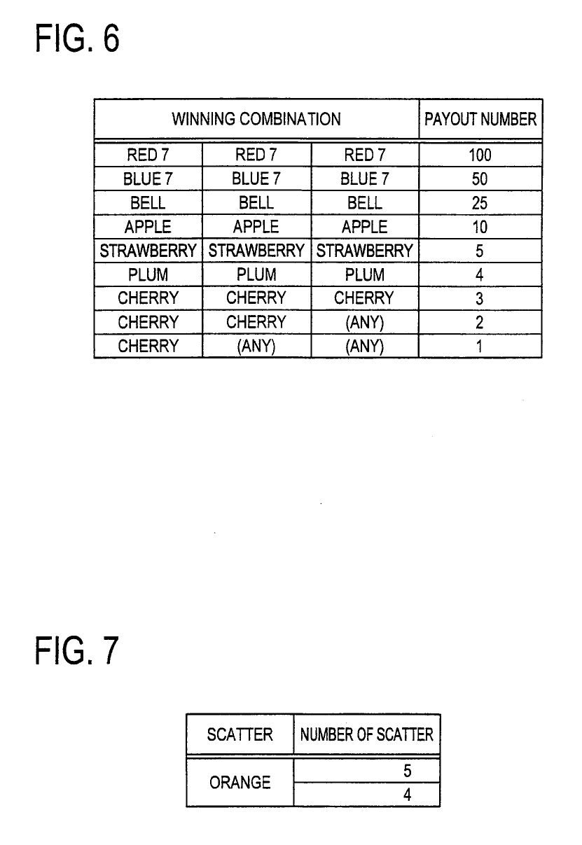

If three same symbols of “RED7”, “BLUE7”, “BELL”, “APPLE”, “STRAWBERRY”, “PLUM”, and “CHERRY” are repositioned on the payline, predetermined payout number will be provided to the player (see FIG. 6). If one of two “CHERRY” symbols are repositioned on the payline L, the predetermined number will be provided to the player based on the number of the symbols.

As shown in FIG. 3, a part of the symbol row displayed on the virtual outer surface of each video reel 5A, 5B, and 5C are displayed, so each three symbols are positioned on each display window 10A, 10B, and 10C and total nine symbols are arranged. When the bet count is determined based on the operation of the 1-bet button 16 or the max-bet button 17, and then the spin button 13 is input, each of the video reel 5A, 5B, and 5C will be spin and the symbols displayed on the virtual outer surface of each video reel 5A, 5B, and 5C will be displayed with scroll in each display window 10A, 10B, and 10C (see FIG. 9). After a predetermined time is elapsed, the video reels 5A, 5B, and 5C will end spinning. Accordingly, the part of the symbol row displayed on the virtual outer surface of each video reel 5A, 5B, and 5C will be displayed on each of the display window 10A, 10B, and 10C and each three symbols are repositioned on each display window 10A, 10B, and 10C, so total nine symbols are repositioned (see FIG. 8). Here, each of the winning combinations (see FIG. 6) may be set beforehand based on the combination of the symbols. If the combination of the symbols displayed on the payline is any of the winning combinations, the payout number corresponding to realized combination will be provided to the player.

Here, the number of “ORANGE” symbols are set beforehand (see FIG. 7). If four or five “ORANGE” symbols are repositioned on each display window 10A, 10B, and 10C, as shown left-third column of FIG. 1, one new visible display window 10D will be displayed on the right side of the display window 10C. Here, on the display window 10D, the part of the symbol row displayed on the virtual outer surface of the video reel 5D, so three symbols are arranged.

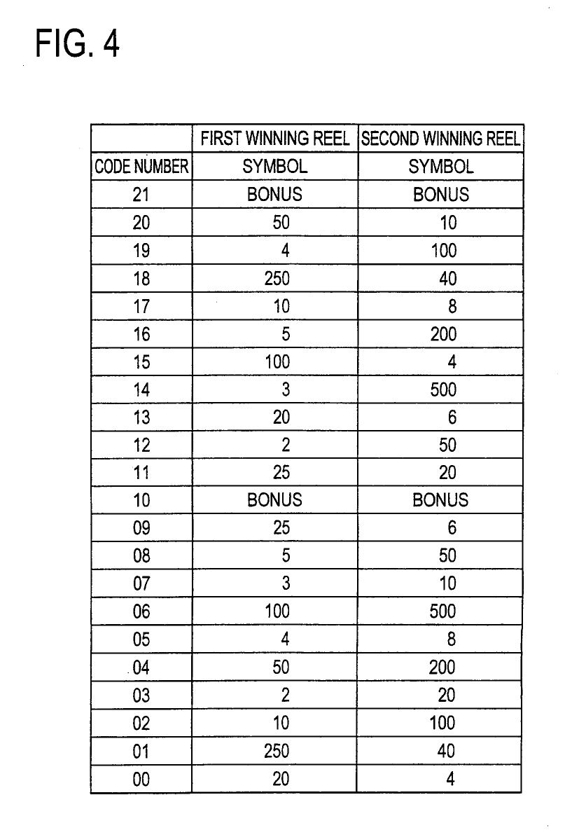

FIG. 4 is a view schematically showing symbol row displayed on the virtual outer surface of the video reel 5D. As shown in FIG. 4, the video reel 5D has the first winning reel and the second winning reel. The first winning reel and the second winning reel have twenty-two symbols thereon respectively. The twenty-two symbols make up the symbol row. The symbol row of the first winning reel include two of “2”, two of “3”, two of “4”, two of “5”, two of “10”, two of “20”, two of “25”, two of “50”, two of “100”, two of “250”, two of “BONUS”. On the other hand, the symbol row of the second winning reel include two of “4”, two of “6”, two of “8”, two of “10”, two of “20”, two of “40”, two of “50”, two of “100”, two of “200”, two of “500”, two of “BONUS”. Here, each of the number displayed on the virtual outer surface of the second winning reel is twice as high as each of the number displayed on the virtual outer surface of the first winning reel. As shown in FIG. 4, symbols are arranged on the virtual outer surface of the first winning reel and the second winning reel in predetermined order.

The part of the symbol rows displayed on the virtual outer surface of the first winning reel and the second winning reel shown in FIG. 4 will be displayed on the display window 10D based on the bet count operated by the user with the use of the 1-bet button 16 or the max-bet button 17. Here, if the maximum bet count is set, the part of the symbol row displayed on the virtual outer surface of the second winning reel will be displayed on the display window 10D as the video reel 5D. On the other hand, if other than the maximum bet count is set, the part of the symbol row displayed on the virtual outer surface of the second winning reel will be displayed on the display window 10D as the video reel 5D.

When the video reel 5D is spin, the symbol row displayed on the virtual outer surface will be displayed on the display window 10D with scroll from the top to the bottom (see right-third column and right-fourth column of FIG. 1). After a predetermined time is elapsed, the video reel 5D will end spinning. Accordingly, the part of the symbol row displayed on the virtual outer surface of video reel 5D will be displayed on the display window 10D and three symbols are repositioned on the display window 10D (see left-fourth of FIG. 1). Here, if the symbol repositioned on the payline L on the display window 5D is the number, the payout number corresponding to the displayed number will be provided to the player. On the other hand, if the symbol repositioned on the payline L on the display window 5D is the text of “BONUS”, the bonus game will be executed. Thereby, the games executed in the slot machine 1 of the embodiment include the base game and the bonus game. In the base game, the game in which predetermined combination is repositioned on the payline L with the use of the vide reel 5A, 5B, and 5C. On the other hand, in the bonus game, the game, which three treasure boxes are displayed on the lower image display panel 6 and the payout number corresponding to selected treasure box among the displayed treasure boxes will be provided to the player, will be executed. Here, the explanation of detailed bonus game will be omitted.

A control system of the slot machine 1 of the embodiment be described with reference to FIG. 5. FIG. 5 is a block diagram schematically showing the control system of the slot machine 1 of the embodiment.

The control system of the slot machine 1 may be constructed from a mother board 40 and a gaming board 50 as shown in FIG. 5.

The gaming board 50 may be composed of a CPU 51, a ROM 55, a boot ROM 52, a card slot 53S, and an IC socket 54S. The CPU 51, the ROM 55, and the boot ROM 52 are interconnected via internal bus. A card slot 53S is adapted to receive the memory card 53. An IC socket 54S is adapted to receive a GAL (Generic Array Logic) 54. Here, PLD (Programmable Logic Device) which is other than the GAL 54 may be substituted for the GAL 54.

The memory card 53 may be constructed from non-volatile memory. Game programs and game system programs (hereinafter, “the game program and the like”) may be stored therein. The game programs stored in the memory card may include lottery program. The lottery program may be used so as to determine symbols (namely, code numbers corresponding to symbols) of the video reels 5A, 5B, and 5C to be displayed on the payline L. The symbol lottery program may include three symbol weighting data table. Each of the weighting data tables corresponds to each plural payout ratios (for example, 80%, 84%, and 88%). The symbol weighting data table may indicate a relation between each of the code numbers for each symbol of the video reels 5A, 5B, and 5C (see FIG. 3) and one or more random number values belonging predetermined range (for example, “0” to “255”). Accordingly, if random number is sampled, the symbol corresponding to sampled random number value may be arranged on the payline.

The lottery program may be also used so as to determine symbol (namely, code numbers corresponding to symbols) of the video reel 5D to be displayed on the payline L. The symbol lottery program may include three symbol weighting data table. Each of the weighting data tables corresponds to each plural payout ratios (for example, 80%, 84%, and 88%). The symbol weighting data table may indicate a relation between each of the code numbers for symbol of the video reel 5D (see FIG. 4) and one or more random number values belonging predetermined range (for example, “0” to “255”). Accordingly, if random number is sampled, the symbol corresponding to sampled random number value may be arranged on the payline.

Here, the payout ratio may be set based on the payout ratio setting data from the GAL 54. Various lotteries may be conducted based on the symbol weighting data corresponding to the payout ratio.

The card slot 53S may be constructed so that the memory card 53 is detachable, and connected to the mother board 40 via bus (for example, IDE bus). The kinds of the game and the contents of the game executed in the slot machine 1 can be changed in a case where the game program and the like stored in the memory card 53. Also, the kinds of games and the contents of the games executed in the slot machine 1 can be changed in a case where the memory card 53 is exchanged to another memory card in which another game program or the like is stored therein.

The game program may include the program related to the gaming session, the image data and sound data as output during the gaming session. Also, the game program may include image data of symbol images displayed on the virtual outer surface of the each video reel 5A, 5B, 5C, and 5D, the image data such as game rules and payout table, image data for demonstration, and the character image (see both sides of fourth column of FIG. 1).

The GAL 54 can be one of the PLD, which may contains a fixed OR array. The GAL 54 has plural input ports and output ports. If predetermined data is input to the input port(s), the data corresponding thereto will output to the output port(s). The output data is the payout ratio setting data.

The IC socket 54S is constructed so that the GAL 54 is detachable, and connected to the mother board 40 via a bus (for example, PCI bus). The payout ratio setting data can be changed in a case where the GAL 54 is re-written or is exchanged.

The CPU 51, the ROM 55, and the ROM 52 are connected to the mother board 40 via the PCI bus. The CPU 51, the ROM 55, and the boot ROM 52 are interconnected via internal bus. The PCI bus transmits the signal between the mother board 40 and the gaming board 50. The mother board 40 supplies the electric power to the gaming board 50. The country ID and the verification program are stored in the ROM 55. The preliminary verification program and the boot code may be stored in the boot ROM 52. The CPU 51 may boot the preliminary verification program with the use of the boot code.

The verification read program is used to verify the game program and the like. The verification program is executed to check whether or not falsification of data has been done. The verification program checks for the falsification of the game program and the like. The game program and the like will be the object of the verification read process. A preliminary verification program may or may not be used to verify the verification program. The preliminary verification program is written along the procedure for the check of falsification of the verification program. The verification program can be the subject of the verification process.

The mother board 40 will be described. The mother board 40 may be constructed from general mother board (printed circuit board which mounts basic components), and may include a main CPU 41, a ROM 42, a RAM 43, and a communication interface 44.

The ROM 42 may be constructed from a memory device such as the flash memory (for example). The preliminary data such as BIOS program and the payout table in the base game and the bonus game (see FIG. 6) and a combination table (see FIG. 7) may be stored in the ROM 42. BIOS program can be executed by the main CPU 41. If the BIOS is executed by the main CPU 41, the initial process for predetermined peripheral devices, and the read process for the game program and the like stored in the memory card 53 will be started via the gaming board 50.

The data and the program, which are used when the main CPU 41 runs, are stored in the RAM 43. The verification program (which will be read via the gaming board 50), various programs (such as the game program and the like), the number of the player's credits, and the number of executed games may be stored in the RAM 43.

The communication interface 44 can be a communication device communicating to the server located in the game hall via a communication line or other communication pathway. The slot machine 1 may communicate bet information in the main game process (which will be described later, see S3 of FIG. 14) and/or the random result of a base winning combination lottery process with the server via the communication interface.

A main PCB (Printed Circuit Board) 60 and a door PCB 80 (which will be described later) are connected to the mother board 40 respectively via USB (for example). A power source unit 45 is connected to the mother board 40. If the power source unit 45 supplies the electric power to the mother board 40, the main CPU 41 on the mother board 40 will be booted up. When the electric power is supplied to the gaming board 50, the CPU 51 will be booted up.

A game controller 100 may be constructed from the mother board 40 and the gaming board 50.

Some devices, which generate the input signal to the game controller 100, are connected to the main PCB 60 and the door PCB 80. Some devices, which are control by the control signal from the game controller 100, are connected to the main PCB 60 and the door PCB 80. The game controller 100 executes the game program and the like stored in the RAM 43 based on the input signal which is input thereto. The game controller 100 stores the calculation result to the RAM 43 and controls some devices by executing predetermined calculation process.

The lamp 35, a sub CPU 61, a hopper 66, a coin detection portion 67, a graphic board 68, the loudspeaker 28 (see FIG. 2), a touch panel 11, the bill verifier 22, the ticket printer 30, the card reader 31, a key switch 33, and data display 32 may be connected directly or indirectly to the main PCB 60.

The touch panel 11 may be arranged in front of the lower image display panel 6. The touch panel 11 can recognize the place where the player touches the touch panel 11 based on the coordinate information of the portion touched by the player. Also, the touch panel 11 can recognize the direction where the player touches and moves based on the coordinate information of the portion touched by the player.

The hopper 66 may be arranged inside of the cabinet 2. The hopper 66 pays a payout with coins through the coin payout opening 23 to the coin tray 24 based on the control signal from the game controller 100. The coin detection portion 67 is arranged inside of the coin payout opening 23. If the coin detection detects that predetermined coins are paid through the coin payout opening 23, the coin detection portion will output the signal to the game controller 100.

The graphic board 68 controls the display image on the upper image display panel 27 and the lower image display panel 6 based on the control signal from the game controller 100. The player's credit count, stored in the RAM 43, may be displayed of the credit count display portion 8. The payout number may be displayed on the payout number display portions 9.

The graphic board 68 may include VDP (Video Display Processor) and a video RAM. The image data generated by the VDP is temporarily stored in the video RAM. The VDP generates the image data based on the control signal from the game controller 100. The data used when the image data is generated by the VDP may be included in the game program.

The graphic board 68 controls so that video reels 5A, 5B, and 5C are spun and displayed on the lower image display panel 6 (see FIG. 1, 8, 9, and 14) based on the control signal from the game controller 100.

The bill verifier 22 verifies the bill or the ticket 25. The bill verifier 22 receives the qualified bill or the ticket 25 into the cabinet 2. When qualified bill is inserted, the bill verifier 22 will output the signal to the game controller 100 based on the value thereof When qualified ticket 25 is inserted, the bill verifier 22 will output to the game controller 100 based on the number of coins printed thereon.

The ticket printer 30 prints the ticket with the bar code in which the data such as credit count stored in the RAM 43 based on the control signal from the game controller 100. The printed ticket is the ticket 25.

The card reader 31 reads from the storage medium (for example, smart card) and transmits the data, which is received by the game controller 100. The card reader writes the storage medium (for example, smart card) based on the control signal from the game controller 100. A keypad 33 is arranged on the key switch 33S. If the keypad 33 is operated by the player, the predetermined input signal will be output to the game controller 100. The data read by the card reader 31 or the data input by the player via the keypad 33 may be displayed on the data display 32 based on the control signal from the game controller 100.

A control panel 22, the coin verifier 21S, and the coin counter 21C are directly or indirectly connected to the door PCB 80. Here, a cold cathode fluorescent lamp 81 may be connected to the door PCB 80. A spin switch 13S, a change switch 14S, a cash-out switch 15S, a 1-bet switch 16S, and a max-bet switch 17S are arranged on the control panel 20. The spin switch 13S is associated with the spin button 13. The change switch 14S is associated with the change button 14. The cash-out switch 15S is associated with the cash-out button 15. The 1-bet switch 16S is associated with the 1-bet button 16. The max-bet switch 17S is associated with the max-bet button 17. Each of switches may output the input signal to the game controller 100 when the button corresponding thereof is operated by the player.

The coin counter 21C is arranged inside of the coin insertion slot 21. The coin counter 21C verifies the coin inserted from the coin insertion slot 21 by the player. Any fake coins may be discharged through the coin payout opening 23. If a qualified coin is detected, the coin counter 21C will output the signal to the game controller 100.

The coin verifier 21S is controlled based on the control signal from the game controller 100. The coin verifier 21S sorts the qualified coins into a cash box (not shown) or the hopper 66. The cash box is arranged inside of the slot machine 1. Here, the lower image display panel 6 is a LED. A cold cathode fluorescent lamp 81 may be arranged back side of the lower image display panel 6 and the upper image display panel 27. Here, a cold cathode fluorescent lamp 81 functions as a back light and turns on based on the control signal from the game controller 100.

The winning combination and payout thereof, in the base game and the bonus game using the reels 5A, 5B, and 5C in the slot machine 1 of the embodiment, will be described with reference to FIG. 6. FIG. 6 shows the payout table which indicates the winning combination, the probability thereof, and the payout number thereof, in the game using the reels 5A, 5B, and 5C.

FIG. 6 indicates the payout number in the case where the bet count is “1”. If the bet count is “1”, the payout number shown in FIG. 6 will be added to the credit count. If the bet count is more than “1”, the payout number shown in FIG. 6 will be multiplied by the bet count, and multiplied number will be added to the credit count.

For example, the winning combination of the “RED7” symbols is realized, three “RED7” symbols is repositioned on the payline L and the payout number of “100 CREDITS” per 1 bet will be provided.

For example, the winning combination of the “BLUE7” symbols is realized, three “BLUE7” symbols is repositioned on the payline L and the payout number of “50 CREDITS” per 1 bet will be provided.

For example, the winning combination of the “BELL” symbols is realized, three “BELL” symbols is repositioned on the payline L and the payout number of “25 CREDITS” per 1 bet will be provided.

In the same way mentioned above, each of the relations between the winning probability and the payout number respectively corresponds to each of the winning combinations shown in FIG. 6. Here, the combination not associated with any of the winning combinations shown in FIG. 6 is realized, the game is lost. If the game is lost, none of the payout number will be paid.

Here, if the total number of “ORANGE” symbols, which are displayed on the each display window 10A, 10B, and 10C regardless of whether or not the “ORANGE” symbols are displayed on the payline L, is a predetermined number, the video reel 5D will be spin and stopped on the display window 5D and an award corresponding to the symbol displayed on the payline L will be provided to the player as the any-payout. FIG. 7 shows a combination table which indicates the number of the repositioned “ORANGE” symbols which is required to spin and stop the video reel 5D on the window display. According to the combination table of FIG. 7, the number of the repositioned “ORANGE” symbols which is required to spin and stop the video reel 5D on the window display is four or five. Here, considering the alignment of the symbols on the each video reel 5A, 5B, and 5C (see FIG. 3), the maximum total number of the repositioned “ORANGE” symbols on each of the display windows 10A, 10B, and 10C is five.

Here, the symbols to be repositioned on the payline L on the display window 5D include “2”, “3”, “4”, “5”, “6”, “8”, “10”, “20”, “25”, “40”, “50”, “100”, “200”, “250”, “500”, or “BONUS” (see FIG. 4). For example, if the symbol displayed on the payline L on the window display 5D is “100”, the payout of “100 CREDITS” will be provided. If the symbol displayed on the payline L on the window display 5D is “BONUS”, the bonus trigger will be won and the bonus game will occur.

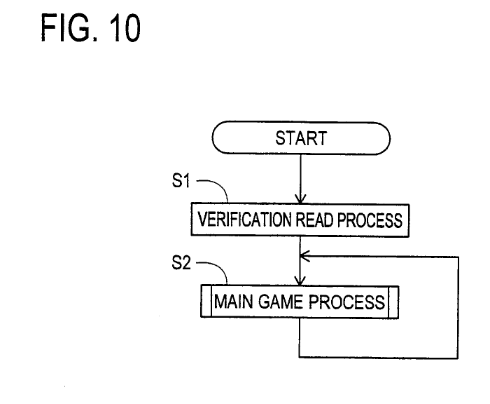

A main control program, which is executed in the slot machine 1 of the embodiment, will be described in detail with reference to the drawing. FIG. 10 is a flowchart of the main control program.

Concerning the slot machine 1, the memory card 53 is connected to the card slot 53S of the gaming board 50, and the GAL 54 is connected to the IC socket 54S.

When the power switch of the power source unit 45 is ON, the game controller 100 are booted-up, and the verification read process (S1) is executed. Here, the game controller 100 may be constructed form the mother board 40 and the gaming board 50. In the verification read process, the mother board 40 and the gaming board 50 execute separate processes in parallel.

In the gaming board 50, the CPU 51 reads the preliminary verification program from the boot ROM 52, and verifies that the verification program is not falsified before the verification program is taken to the mother board 40.

In the mother board 40, the main CPU 41 executes BIOS stored in the ROM 42, and checks and initializes various peripheral devices. Here, BIOS may be compressed, then, BIOS is decompressed. BIOS may be copied to the RAM 43.

The game controller 100 reads the verification program stored in the ROM 55, and verifies that game program and the like are not falsified. Here, the game program and the like is stored in the memory card 53 which is inserted to the card slot 53S. After the verification process is ended, the game controller 100 writes program to the RAM 43, and acquires payout data and country ID.

After the process mentioned above is finished, the game controller 100 finishes the verification read process.

In S2, the game controller 100 reads the game program and the like which was verified in S1 from the RAM 43, and executes the main game process. The game in the slot machine 1 of the embodiment is executed by executing the main game process. The main game process is executed repeatedly during the electronic power source is supplied.

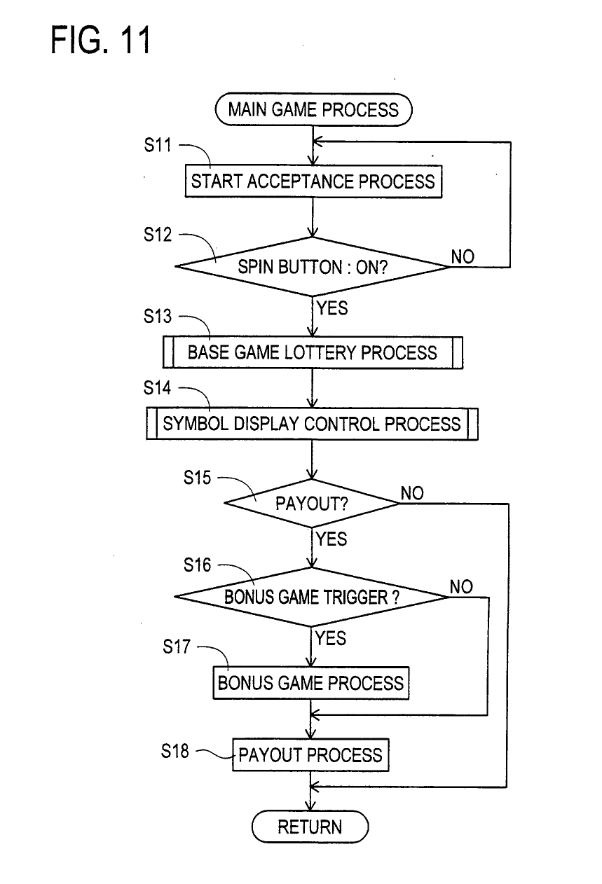

A sub process of the main game process in S2 will be described with reference to FIG. 11. FIG. 11 is a flowchart of the main game process in the slot machine 1 of the embodiment. Here, each of the programs shown in the flowcharts in FIG. 11 is stored in the memory card 53. The programs are decompressed to the RAM 43, and decompressed programs are executed by the game controller 100.

In S11, the game controller 100 performs predetermined initial setting, and then, executes the start acceptance process as shown in FIG. 11. The coin is inserted and the bet count for the payline is set during the start acceptance process. The coin is inserted by the player, or the bet operation with the use of the 1-bet button 16 or max-bet button 17 is operated by the player.

In the predetermined initial setting, the game controller 100 initializes predetermined information stored in the RAM 43 and erases the window display 10D on the lower image display panel 6. Here, the predetermined information to be initialized stored in the RAM 43 include each lottery result (code number) in S21, S24, and S25 (which will be described later). If the game controller 100 sends predefined control signal to the graphic board 68, the display window 10D will be erased.

In S12, the game controller 100 determines whether or not the spin button 13 is operated. It is determined whether or not the spin button 13 is operated based on that whether or not the input signal is received.

If the spin button 13 is not operated (S12:NO), the procedure will be returned to the start acceptance process (S11) again. In that time, some instructions such as to change the bet count are available. On the other hand, if the spin button 17 is operated (S12:YES), the bet count, which is set for the payline L based on the operation of 1-bet button 16 or max-bet button 17, will be subtract from credit count in which the player owns. And, the bet count will be stored in RAM 43 as the bet information.

If the game controller 100 sends a predefined control signal to the graphic board, the bet count and the credit count corresponding to the bet information will be displayed in the bet count display portion 101 and the credit count display portion 8 (see right-second column of FIG. 1).

Beginning in S13, the game controller 100 executes the base game with the use of the video reels 5A, 5B, and 5C.

At first, in S13, the game controller 100 executes a base game lottery process.

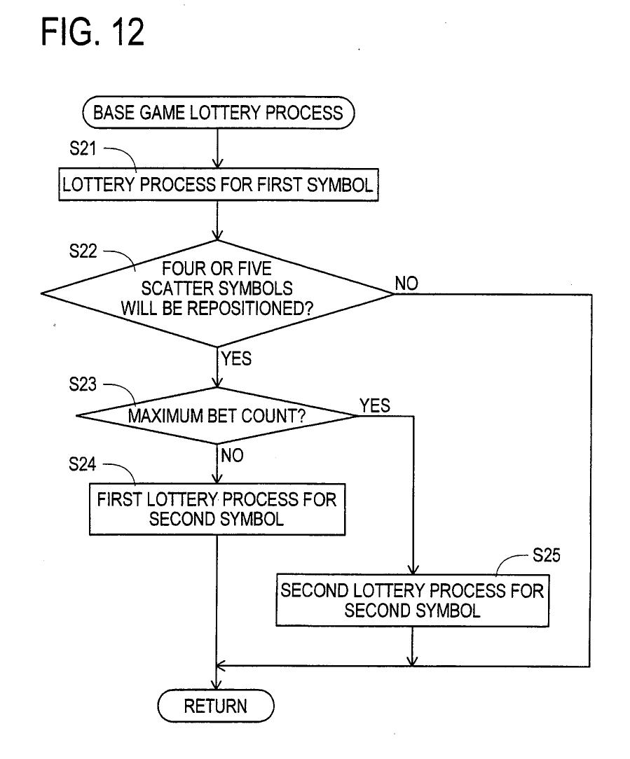

A sub process of the base game process in S13 will be described with reference to FIG. 12. FIG. 12 is a flowchart of the base game process in the slot machine 1 of embodiment of the slot machine 1. Here, each of the programs shown in the flowchart in FIG. 12 is stored ROM 42 or RAM 43, and is executed by the game controller 100.

As shown in FIG. 12, in S21, the game controller 100 executes the lottery process for the first symbol.

Concretely, the game controller 100 executes random number value generation program included in lottery program stored in the RAM 43, at result, each of the random number values of each reel 5A, 5B, and 5C is generated from the predetermined range of the random number value (“0” to “255”, for example). The code numbers of the video reels 5A, 5B, and 5C (see FIG. 3) may be determined based on three random number values and the symbol weighting table. Each of the symbol weighting tables corresponds to the payout ratio setting data. The procedure will be shifted to S22 after the code numbers of each symbol of each the video reel 5A, 5B, and 5C are stored in the RAM 43.

Here, each of the code number of the video reels 5A, 5B, and 5C corresponds to each of the code numbers of symbols to be rearranged on the payline. Accordingly, the game controller 100 determines the combination of symbols in current game by determining each of the code numbers of video reels 5A, 5B, and 5C. For example, if it is determined that code numbers of each video reel 5A, 5B, and 5C is “00”, “00”, and “00” respectively, the game controller 100 will determines that symbols combination is the winning combination of “RED7”. Thereby, nine symbols to be repositioned on the each display windows 10A, 10B, and 10C are determined. Accordingly, the lottery for symbols combination (see FIG. 6) is conducted by determining the code numbers of each video reel 5A, 5B, and 5C.

In S22, the game controller 100 determines whether or not four or five scatter symbols will be displayed on each window displays 10A, 10B, and 10C in the unit game. This determination is based on the code numbers stored in the RAM 43 in S21 or the code numbers of each video reel 5A, 5B, and 5C. If it is determined that four or five scatter symbols of “ORANGE” symbols will not be repositioned on each display window 10A, 10B, and 10C (S22:NO), the procedure will be returned the main game process of above mentioned in FIG. 11 and shifted to S14. On the other hand, if it is determined that four of five scatter symbols of “ORANGE” symbols will be repositioned on each display window 10A, 10B, and 10C (S22:YES), the procedure will be shifted to S23.

In S23, the game controller 100 determines whether or not the maximum bet count is set. It is determined based on the bet information stored in the RAM 43 in S12. If it is determined that the maximum bet count is not set (S23:NO), the procedure will be shifted to S24 and the first lottery process for the second symbol will be executed and then will be returned to the main game process of FIG. 11 and will be shifted S14. On the other hand, if it is determined that the maximum bet count is set (S23:YES), the procedure will be shifted to S25 and the second lottery process of the second symbol will be executed and then will be returned to the main game process of FIG. 11 and will be shifted S14.

The first lottery process for the second symbol in S24 will be described concretely. In the first lottery process of the second symbol in S24, the game controller 100 executes random number value generation program included in lottery program stored in the RAM 43, at result, the random number value of the first winning reel (which is the video reel 5D) is generated from the predetermined range of the random number value (“0” to “255”, for example). The code number of the first video reel (see FIG. 4) may be determined based on one random number value and the symbol weighting table. Each of the symbol weighting tables corresponds to the payout ratio setting data. The procedure will be returned to the main game process of FIG. 11 shifted to S14 after the code number of the first winning reel is stored in the RAM 43 with information which indicates the code number is for the first winning reel.

The code number of the first winning reel indicates the symbol of the video reel 5D re-arranged on the payline L on the display window 10D, so if the game controller 100 determines the code number of the first winning reel, any-payout in current unit game will be determined. For example, if it is determined that the code number of the first winning reel is “00”, the game controller determines that the any-payout in current unit game is the payout number “20” (see FIG. 4). In this manner, the lottery for the any-payout in current unit game is conducted by determining the code number of the first winning reel.

The second lottery process for the second symbol in S25 will be described concretely. In the second lottery process for the second symbol in S25, the game controller 100 executes random number value generation program included in lottery program stored in the RAM 43, at result, the random number value of the second winning reel (which is the video reel 5D) is generated from the predetermined range of the random number value (“0” to “255”, for example). The code number of the second video reel (see FIG. 4) may be determined based on one random number value and the symbol weighting table. Each of the symbol weighting tables corresponds to the payout ratio setting data. The procedure will be returned to the main game process of FIG. 11 shifted to S14 after the code number of the second winning reel is stored in the RAM 43 with information which indicates the code number is for the second winning reel.

Here, the code number of the second winning reel indicates the symbol to be displayed on the display window 5D, so when the game controller 100 determines the code number of the second winning reel, the award of the any-payout will be determined. For example, if it is determined that the code number of the second winning reel is “00”, the game controller 100 determines that the award of the any-payout in the unit game is the payout number of “4” (see FIG. 4). In this way, the lottery for the award of the any-payout in the unit game is conducted by determining the code number of the second winning reel.

When the procedure is returned to the main game process of FIG. 11 and is shifted to S14, the game controller 100 executes the symbol display control process.

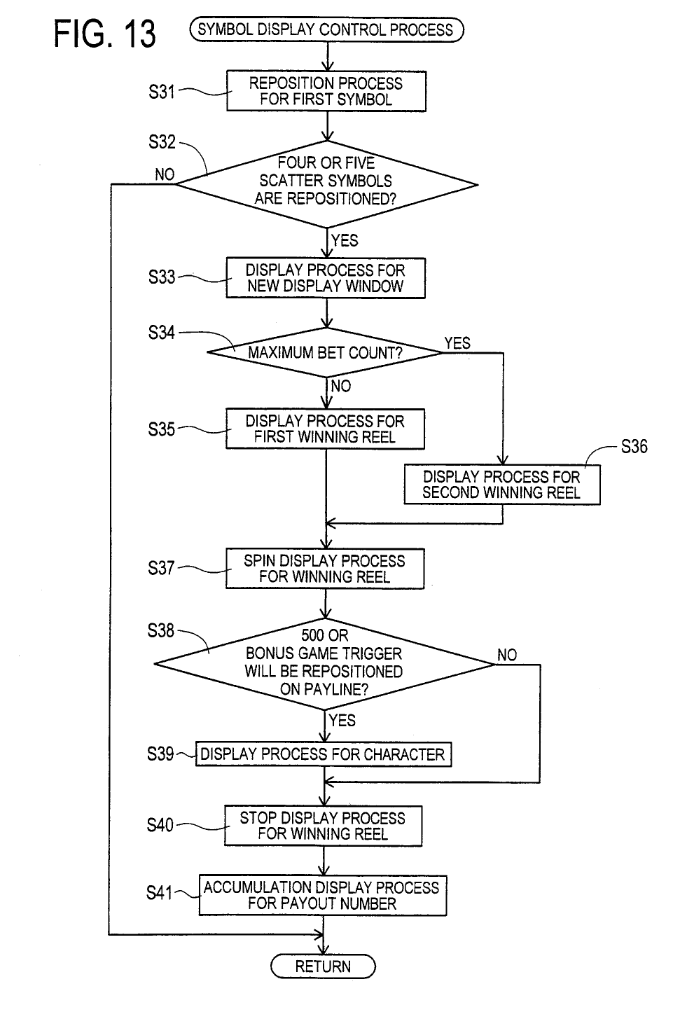

A sub process of the reel spin control process of S14 will be described with reference to FIG. 13. FIG. 13 shows a flowchart of the reel spin control process. The programs which are executed as methods of the flowchart shown in FIG. 13 may be stored in the ROM 42 and the RAM 43 in the slot machine 1, and may be executed by the game controller 100.

As shown in FIG. 13, the game controller 100 executes the reposition process in S31. In the reposition process, each video reel 5A, 5B, and 5C is spin and then stopped so that symbols combination determined in the lottery process for the first symbol is repositioned on the payline L. The reposition process is executed by the game controller 100 and the graphic board 68.

At first, the game controller 100 sends the start signal that instructs the video reels to start to spin, to the graphic board 68. When the graphic board 68 receives the start signal, the graphic board 68 will executes the video reel spin display process. That is, the graphic board 68 controls so that each of the video reels 5A, 5B, and 5C are spun and displayed on the lower image display panel 6 (see right-second column of FIG. 1).

After the start signal is sent, the game controller 100 determines a production pattern (for example, the image display on the upper image display panel 7 and output sound from the loudspeaker 28), and the determined production pattern will be conducted.

When it becomes predetermined timing in which the video reels 5A, 5B, and 5C are to be stopped, the game controller 100 will transmit the code numbers stored in the RAM 43 to the graphic board 68. The graphic board 68 executes the video reel stop display process based on the code numbers of the video reel. Accordingly, it is determined that the symbols corresponding to the lottery result in S21 will be displayed on the payline L on the each window display 10A, 10B, and 10C on the lower image panel 6 (for example, see left-second column of FIG. 1).

If the combination of three symbols repositioned on the payline L is any of the winning combination (see FIG. 6), the game controller 100 will send the control signal to the graphic board 68. Thereby, the payout number corresponding to the winning combination will be multiplied by the bet count, and multiplied number will be displayed in the payout number display portion 9 (see left-second column of FIG. 1).

In S32, the game controller 100 determines the number of repositioned scatter symbols on the display windows 10A, 10B, and 10C. It is determined based on the code numbers stored in the RAM 43 in S21 or the code numbers of each video reel 5A, 5B, and 5C. If it is determined that three or less scatter symbols of “ORANGE” are positioned on the display windows 10A, 10B, and 10C (S32:NO), the procedure will be returned to the main game process of FIG. 11 and will be shifted to S15. On the other hand, if it is determined that four or five scatter symbols of “ORANGE” is repositioned on the display windows 10A, 10B, and 10C (S32:YES), the procedure will be shifted to S33.

In S33, the game controller 100 executes the display process for new display window. In the display process for the new display window, the new display window 5D is displayed on the right side of the display window 10C (see left-third column of FIG. 1). The display process for new display window is executed in the game controller 100 and the graphic board 68.

In S34, the game controller 100 determines whether or not the maximum bet count is set. This determination is based on the bet information stored in the RAM 43 in S12. If it is determined that the maximum bet count is not set (S34:NO), the procedure will be shifted to S35 and the display process for the first winning reel will be executed. In this process, the part for the first winning reel (which is as the part of the video reel 5D) is displayed on the display window 10D on the lower image display panel 6. The display process for the first winning reel is executed in the game controller 100 and the graphic board 68. After that, the procedure is shifted to S37. On the other hand, in S34, if it is determined that the maximum bet count is set (S34:YES), the procedure will be shifted to S36 and the display process for the second winning reel will be executed. In the display process for the second winning reel, as shown in left-middle column of FIG. 1, the part of the second winning reel (which is as the part of the video reel 5D) is displayed on the display window 10D on the lower image display panel 6. The display process of the second winning reel is executed in the game controller 100 and the graphic board 68. After that, the procedure is shifted to S37.

In S37, the game controller 100 executes the spin display control process for the winning reel. In this process, the video reel 5D is started to spin. Here, if the process in S35 is executed, the first winning reel (which is as the video reel 5D) will be started to spin in S37. On the other hand, if the process in S36 is executed, the second winning reel (which is as the video reel 5D) will be started to spin in S37. Here, this process is executed by the game controller 100 and the graphic board 68. Concretely, the game controller 100 sends the start signal that instructs the video reel to start to spin, to the graphic board 68. If the graphic board 68 is received the start signal, the video reel spin display process will be executed. That is, the graphic board 68 controls so that the video reel 5D is started to spin in the lower image display panel 6 (see left-bottom column of FIG. 1).

In S38, the game controller 100 determines whether or not the symbol “500” or “BONUS” will be repositioned on the payline L on the display window 10D. This process is based on the code number stored in the RAM 43 in S24 and S25, and/or information. If it is determined that the symbol of “500” and “BONUS” will not be repositioned on the payline L on the window display 5D (S38:NO), the procedure will be shifted to S40 (which will be described later). On the other hand, if it is determined that the symbols “500” or “BONUS” will be repositioned on the payline L on the window display 5D (S38:YES), the procedure will be shifted to S39.

In 39, the game controller 100 executes the display process for the character. In this process, for example, as shown in both fourth columns of FIG. 1, an image effect which the character 102 stops the spinning video reel 5D is conducted on the lower image display 6.

This process is executed by the game controller 100 and the graphic board 68.

Accordingly, if the symbol “500” or “BONUS” will not be repositioned on the payline L on the window display 10D, the image effect which the character 102 stops the spinning video reel 5D is not conducted on the lower image display 6.

In S40, the game controller 100 executes the stop display process for the winning reel. In this process, the spinning video reel 5D is stopped so that the symbol determined in the first lottery process for the second symbol (S24) or the second lottery process for the second symbol (S25) is repositioned on the payline L on the window display 10D. This process is executed by the game controller 100 and the graphic board 68.

Concretely, when it becomes predetermined timing in which the video reels 5D is to be stopped, the game controller 100 will transmit the code number of the video reel 5D stored in the RAM 43 to the graphic board 68. The graphic board 68 executes the video reel stop display process based on the code number of the video reel 5D. Accordingly, the symbol corresponding to the lottery result in S24 or S25 will repositioned on the payline L on the window display on the lower image display panel 6 (for example, see left-fourth column of FIG. 1).

In S41, the game controller 100 executes the accumulation display process for the payout number. In this process, if the symbols repositioned on the payline L on the display window 10D is the number, the game controller 100 will send the predefined control signal to the graphic board 68. Thereby, the number display in the payout number display portion 9 is added to the repositioned number, and the accumulated number is displayed (see both fourth columns of FIG. 1). The accumulated number is stored in the RAM 43 as the payout information.

After that, the procedure will be returned to the main game process of FIG. 11, and the shifted to S15.

When the procedure will be returned to the main game process of FIG. 11, the game controller 100 determines whether or not the winning combination is realized in S15. This determination is based on the lottery result (code number) stored in the RAM 43 in S21, S24 or S25, for example. That is, if the lottery result (code number) stored in the RAM 43 in S21 is any of the winning combination or lottery result (code number) stored in the RAM 43 in S24 or 25 is any of the winning combination, it will be determined that the winning combination is realized. On the other hand, it is determined that the lottery result (code number) stored in the RAM 43 in S21 is none of the winning combination and the lottery result (code number) stored in the RAM 43 in S24 and S25 is none of the winning combination, it will be determined that the winning combination will not be realized. If it is determined the winning combination is realized (S15:YES), the procedure will be shifted to S16. On the other hand, it is determined that the winning combination is not realized (S15:NO), this program will be executed again.

In S16, the game controller 100 determines whether or not the bonus game trigger is realized. This determination is based on the lottery result (code number) in S24 or S25. Concretely, if the symbol of “BONUS” is repositioned on the payline L on the display window 10D, it will be determined that the bonus trigger is realized.

If it is determined that the bonus trigger is realized (S16:YES), the game controller 100 executes the selection-type bonus game in S17. Here, the detailed explanation of the bonus game will be omitted. After that, the game controller 100 executes the payout process (S18). Here, if it is determined that the bonus trigger is not realized (S16:NO), the procedure will be shifted to S18. In the payout process, the payout number obtained in the base game and the bonus game (the number displayed in the payout number display portion 9) will be provided to the player. Here, the game controller 100 sends the predefined control signal to the graphic board 68. Thereby, the number displayed in the credit count display portion 8 is added to the number displayed in the payout number display portion 9, and accumulated number is newly displayed in the credit count display portion 9, and “0” is displayed in the payout number display portion 9.

In this time, if the cashout button 15 is pressed, the coin corresponding to the credit count (for example, one credit is equal to one coin) may be paid or the ticket 25 may be printed.

After that, the procedure will be shifted to the main game process.

Here, aspects of the present invention are not limited to the above embodiment and various changes and modification can be done within the scope of the present invention.

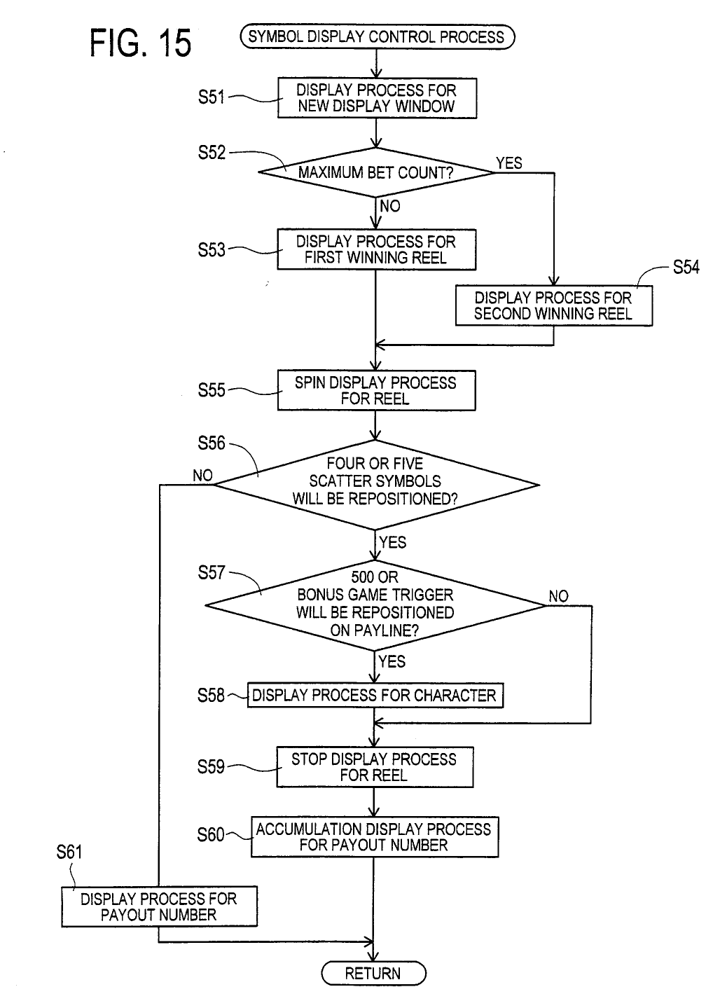

For example, as shown in FIG. 14, the spin and stop for the each video reel 5A, 5B, and 5C on the each display window 10A, 10B, and 10C, and the spin and stop for the video reel 5D on the display window 5D are conducted, at the same time. Here, to execute this process, the game controller 100 has to execute a sub process of the symbol display control process shown in FIG. 15 in place of the sub process of the symbol display control process shown in FIG. 13.

The sub process of the symbol display control process shown in FIG. 15 will be described. FIG. 15 shows a flowchart of the symbol display control process in the slot machine 1 of the embodiment. Here, each of the programs shown in the flowcharts in FIG. 15 is stored in the memory card 53. The programs are stored in the ROM 42 or the RAM 43, and stored programs are executed by the game controller 100.

At first, as shown in FIG. 15, in S51, the game controller 100 executes the display process of new display window. In this process, the window display window 5D is newly displayed on the right side of the window display 10C on the lower image display panel 6 (see right-second column of FIG. 14). Here, this process is executed in the game controller 100 and the graphic board 68.

In S52, the game controller 100 determines whether or not the maximum bet count is set. This determination is based on the bet information stored in the RAM 43 in S12. If it is determined that the maximum bet count is not set (S52:NO), the procedure will be shifted to S53 and the display process for the first winning reel will be executed. In this process, the part of the first winning reel (which is as the part of the video reel 5D) is displayed on the display window 10D on the lower image display panel 6. The display process for the first winning reel is executed in the game controller 100 and the graphic board 68. After that, the procedure is shifted to S55. On the other hand, in S52, if it is determined that the maximum bet count is set (S52:YES), the procedure will be shifted to S54 and the display process for the second winning reel will be executed. In the display process for the second winning reel, as shown in right-first column of FIG. 14, the part of the second winning reel (which is as the part of the video reel 5D) is displayed on the display window 10D on the lower image display panel 6. In FIG. 14, as shown in right-first column, the player press the max-bet button 17 and the maximum bet count is set, the part of the second winning reel is displayed on the window display 10D on the lower image display panel 6 as the part of the video reel 5DE. The display process for the second winning reel is executed in the game controller 100 and the graphic board 68. After that, the procedure is shifted to S55.

In S55, the game controller 100 executes the spin display control process for the winning reel. In this process, the video reel 5A, 5B, and 5C, and 5D are started to spin. Here, if the process in S53 is executed, the first winning reel (which is as the video reel 5D) will be started to spin in S55. On the other hand, if the process in S54 is executed, the second winning reel (which is as the video reel 5D) will be started to spin on the display window 5D on the lower image panel 6 in S55. Here, this process is executed by the game controller 100 and the graphic board 68. Concretely, the game controller 100 sends the predefined start signal that instructs the video reel to start to spin, to the graphic board 68. If the graphic board 68 is received the start signal, the video reel spin display process will be executed. That is, the graphic board 68 controls so that the video reel 5A, 5B, 5C, and 5D are started to spin in the lower image display panel 6 (see left-second column of FIG. 14).

In S56, the game controller 100 determines the total number of the scatter symbols to be repositioned on the each display window 10A, 10B, and 10C in the unit game. This determination is based on the code number stored in the RAM 43 in S21 or the code numbers of each video reel 5A, 5B, and 5C. If it is determined that less than four scatter symbols of “ORANGE” will be repositioned on the each display window 10A, 10B, and 10C (S56:NO), the procedure will be shifted to S61 (which will be described later). On the other hand, four or five scatter symbols of “ORANGE” will be repositioned on each display window 10A, 10B, and 10C (S56:YES), the procedure will be shifted to S57.

In S57, the game controller 100 determines whether or not the symbol “500” or “BONUS” will be repositioned on the payline L on the display window 10D. This process is based on the code number stored in the RAM 43 in S24 or S25, and/or information. If it is determined that the symbol of “500” and “BONUS” will not be repositioned on the payline L on the window display 5D (S57:NO), the procedure will be shifted to S59 (which will be described later). On the other hand, if it is determined that the symbols “500” or “BONUS” will be repositioned on the payline L on the window display 5D (S57:YES), the procedure will be shifted to S58.

In 58, the game controller 100 executes the display for the character. In this process, for example, as shown in both third columns of FIG. 14, the image effect which the character 102 stops the spinning video reel 5D is conducted on the lower image display 6.

This process is executed by the game controller 100 and the graphic board 68.

Accordingly, if the symbol “500” or “BONUS” will not be repositioned on the payline L on the window display 10D, the image effect which the character 102 stops the spinning video reel 5D is not conducted on the lower image display 6.

In S59, the game controller 100 executes the stop display process for the winning reel. In this process, the spinning video reels 5A, 5B, and 5C are stopped so that the symbols combination determined in the lottery process for the first symbols (S24) is rearranged on the payline L. Also, in this process, the spinning the spinning video reel 5D is stopped so that the symbol determined in the first lottery process for the second symbol (S24) or the second lottery process for the second symbol (S25) is repositioned on the payline L on the display window 10D. This process is executed by the game controller 100 and the graphic board 68.

Concretely, when it becomes predetermined timing in which the video reels 5A, 5B, and 5C are to be stopped, the game controller 100 will transmit the code numbers stored in the RAM 43 to the graphic board 68. The graphic board 68 executes the video reel stop display process based on the code numbers. Accordingly, the symbols corresponding to the lottery results in S21 are rearranged on the display windows 10A, 10B, and 10C (for example, see right-third column of FIG. 14).

Concretely, when it becomes predetermined timing in which the video reel 5D, is to be stopped, the game controller 100 will transmit the code number of the video reel 5D stored in the RAM 43 to the graphic board 68. The graphic board 68 executes the video reel stop display process based on the code number of the video reel 5D. Accordingly, the symbol corresponding to the lottery results in S24 or S25 is repositioned on the payline L on the display windows 10D (for example, see right-third column of FIG. 14).

Here, the predetermined timing in which the video reel 5A, 5B, and 5C will be stopped and the predetermined timing in which the video reel 5D will be stopped, are the same.

In S60, the game controller 100 executes the accumulation display process for the payout number. In this process, if the symbols repositioned on the payline L on the display window 10D is the number, the game controller 100 will send the control signal to the graphic board 68. Thereby, the number corresponding to the symbols combination displayed on the payline L on the display windows 10A, 10B, and 10C is added to the repositioned number of the display window 10D, and the accumulated number is displayed (see right-third column of FIG. 14). The accumulated number is stored in the RAM 43 as the payout information.

After that, the procedure will be returned to the main game process of FIG. 11, and will be shifted to S15.

On the other hand, in S56, if it is determined that less than four scatter symbols of “ORANGE” will be repositioned on the each display window 10A, 10B, and 10C (S56:NO), the procedure will be shifted to S61. In S61, the game controller 100 executes the display process for the payout number. In this process, the game controller 100 send the control signal to the graphic board 68, and the payout number corresponding to the symbols combination on the payline L on the display windows 10A, 10B, and 10C is displayed in the payout number display portion 9. Here, the number will be stored in the RAM 43 as the bet information.

After that, the procedure will be returned to the main game process, and shifted to S15.

### Second Embodiment

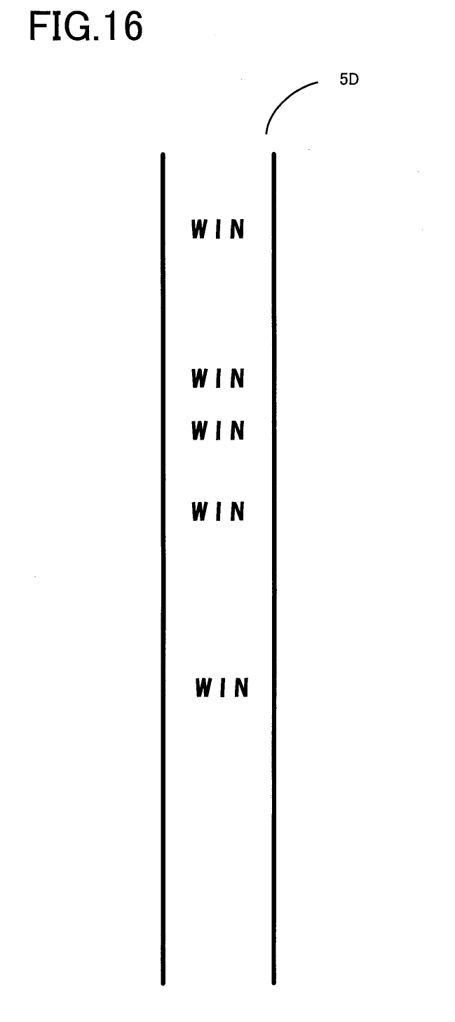

Another aspect of invention will be described. In this embodiment, the first winning reel has only “WIN” symbol. That is, only “WIN” symbols are displayed on the first winning reel. FIG. 16 shows an example of the first winning reel of this embodiment. As shown in FIG. 16, the “WIN” symbols are displayed on the first reel with predetermined number. Here, the number of the “WIN” symbols displayed on the first reel is variable. And, the distance of each “WIN” symbol is variable. Here, another symbol may be replaced with the “WIN” symbol.

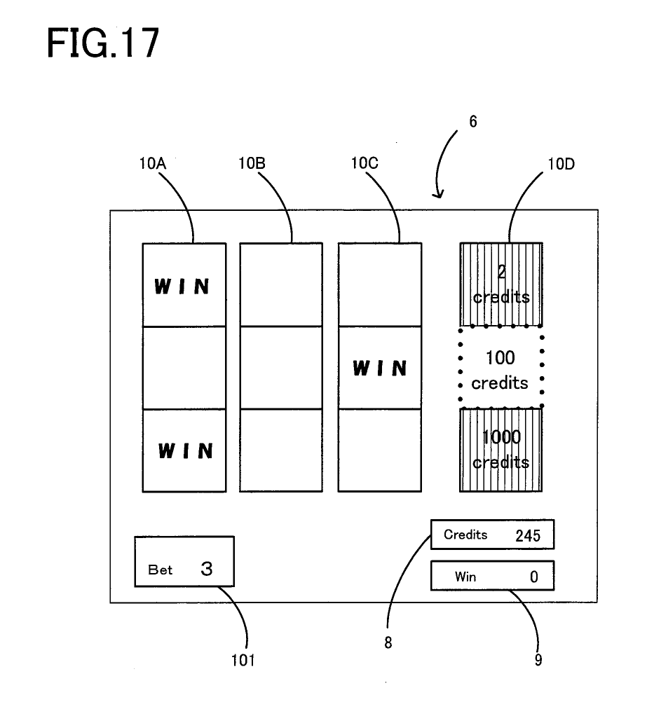

In this embodiment, the payline is not used. FIG. 17 shows a sample display screen displayed on the lower image display panel 6. As shown in FIG. 17, only three “WIN” symbols are displayed on the display windows 10A, 10B, and 10C. That is, some portions of the display windows 10A, 10B, and 10C are blank. Here, if the number of displayed “WIN” symbols is a predetermined number or above, the second winning reel will be spin and stopped on the display window 10D. Here, the predetermined number may three. The second winning reel used in this embodiment may be the same as the second winning reel used in the first embodiment. Also, the number of the display windows on which the first winning reels are spin and stopped is variable. For example, the number of display windows on which the first winning reel are spin and stopped may be four. In FIG. 17, “100 credits” displayed on center portion of the display window 10D is won. Here, symbols which are next to “100 credits” (“2 credits” and “1000 credits”) may be visible through dark background (see FIG. 17). Here, the display patterns of the display window 10D may be the same as the display pattern of the display window 10D of the first embodiment.

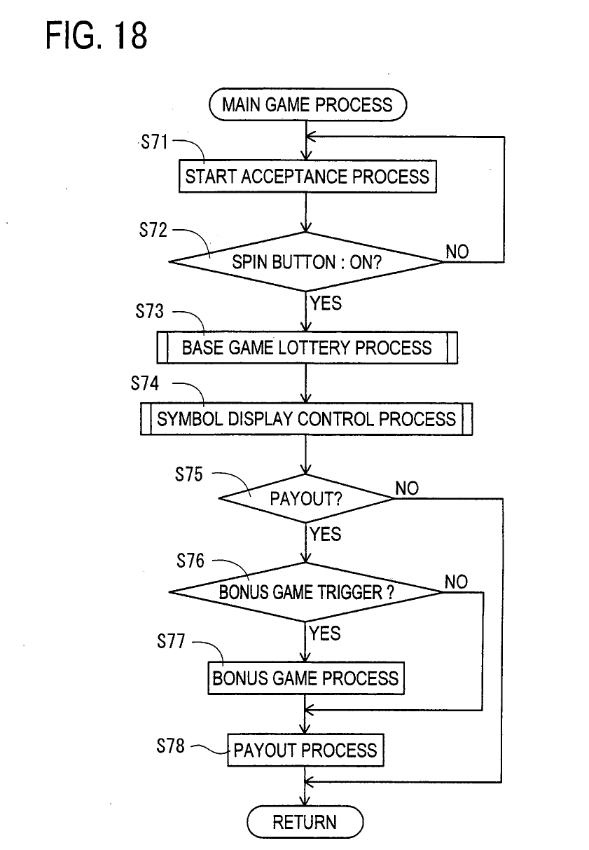

FIG. 18 is a flowchart of the main game processes in the slot machine 1 of this embodiment. A process of S71, S72, S74, S76 to S78 can be the same as the process S11, S12, S14, S16 to S18 of FIG. 11 respectively, so explanations of that will be omitted.

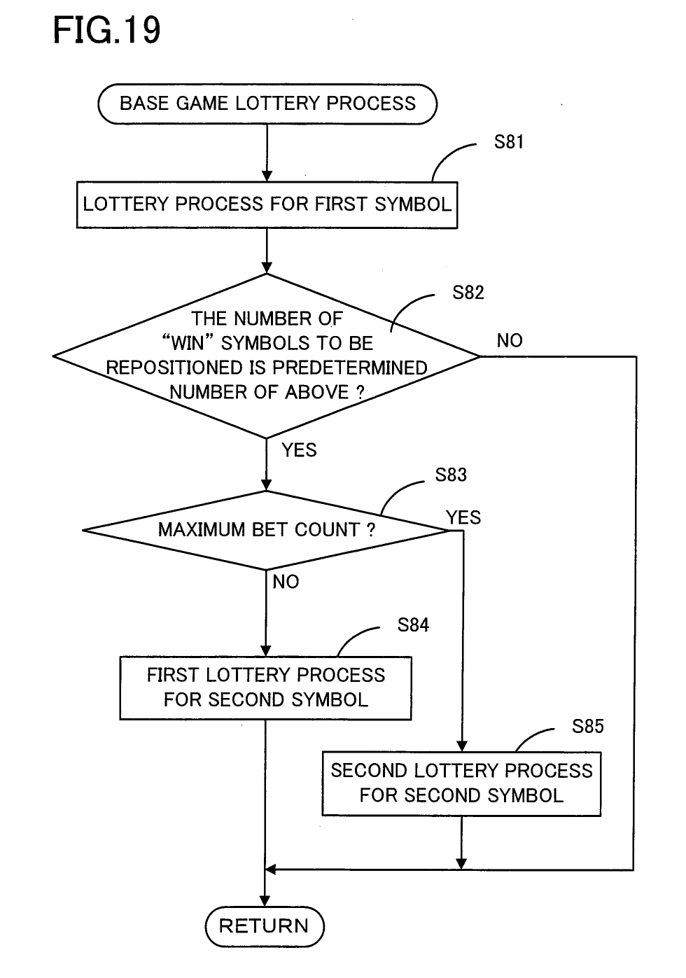

A base game lottery process (S73) will be described with reference to FIG. 19. FIG. 19 is a flowchart of the base game process in the slot machine 1 of this embodiment. A process of S81, S83, S84, and S85 can be the same as the process S21, S23, S24, and S25 of FIG. 12 respectively, so explanations of that will be omitted. A process of S82 of FIG. 19 will be described. In S82, the game controller 100 determines whether or not the number of displayed “WIN” symbols is a predetermined number or above. This determination is based on the code numbers stored in the RAM 43 in S81 or the code numbers of each video reel 5A, 5B, and 5C. If it is determined that “WIN” symbols will be displayed on the 10A, 10B, and 10C with the predetermined number or above (S82:YES), the procedure will be shifted to S83. On the other hand, if it is determined that “WIN” symbols will not be displayed on the 10A, 10B, and 10C with the predetermined number or above (S82:NO), the base game lottery process will be finished.

The process of S75 of FIG. 17 will be described. In S75, the game controller 100 determines whether or not the winning combination is realized. This determination is based on the lottery result (code number) stored in the RAM 43 in S84 or S85. That is, if the lottery result (code number) stored in the RAM 43 in S84 or 85 is any of the winning combination, it will be determined that the winning combination is realized. On the other hand, it is determined that the lottery result (code number) stored in the RAM 43 in S84 and S85 is none of the winning combination, it will be determined that the winning combination will not be realized. If it is determined the winning combination is realized (S85:YES), the procedure will be shifted to S86. On the other hand, it is determined that the winning combination is not realized (S85:NO), this program will be executed again.

In this embodiment, an image effect in which a character stops spinning video reel 5D may be conducted on the lower image display panel 6 the same as FIG. 14.

According to this embodiment, the player can easily recognize the game result by only counting the “WIN” symbols.

### Third Embodiment

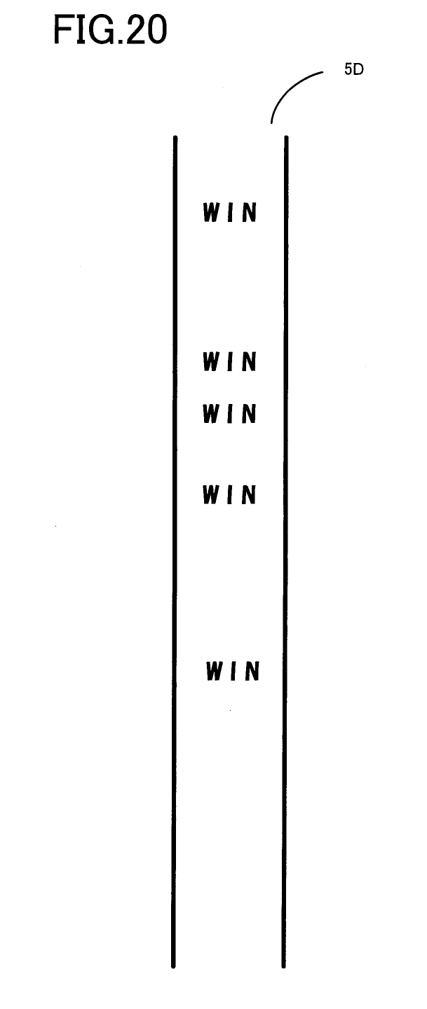

Another aspect of the invention will be described. In this embodiment, in the bonus game of S17 of FIG. 12, the game will be executed with the use of the bonus reel. FIG. 20 shows an example of the bonus reel used in this embodiment. As shown in FIG. 20, the “WIN” symbols are displayed on the bonus reel with predetermined number. And, the bonus reel has only “WIN” symbol. That is, only “WIN” symbols are displayed on the bonus reel. Here, the number of the “WIN” symbols on the bonus reel is variable. And, the distance of each “WIN” symbol is variable. Here, another symbol may be replaced with the “WIN” symbol. In this embodiment, the payline is not used in the bonus game. The second winning reel used in the bonus game in this embodiment may be the same as the second winning reel used in the first embodiment.

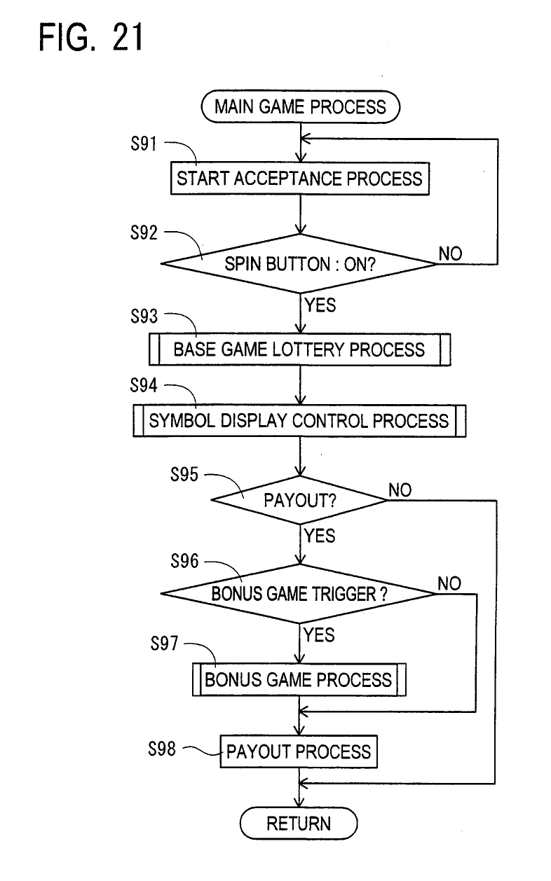

FIG. 21 is a flowchart of the main game processes in the slot machine 1 of this embodiment. A process of S91 to S96 and S98 can be the same as the process S11 to S16 and S18 of FIG. 11 respectively, so explanations of that will be omitted.

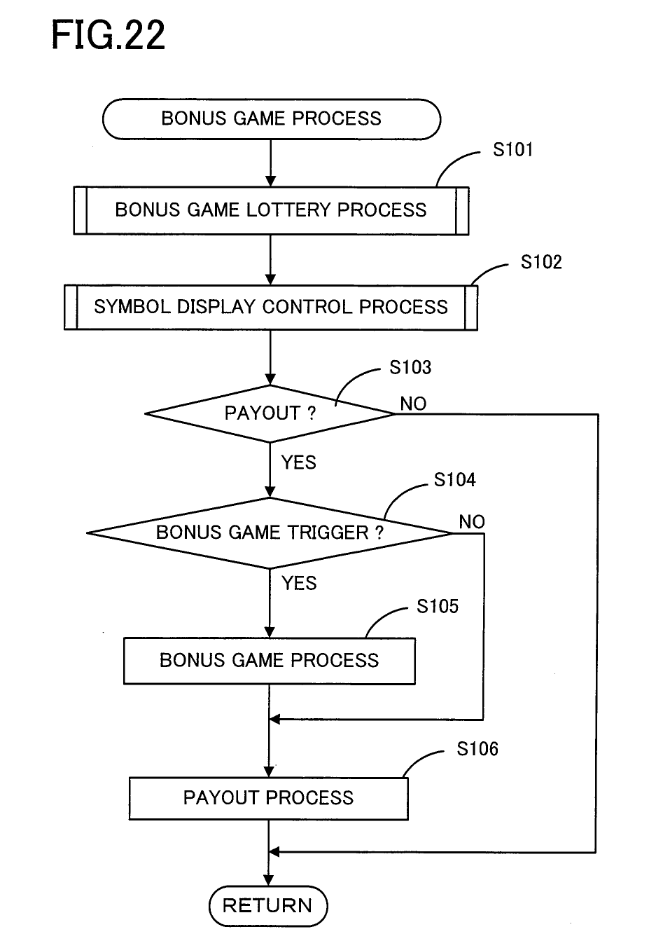

The bonus game process of S97 will be described with reference to FIG. 22. FIG. 22 is a flowchart of the bonus game processes in the slot machine 1 of this embodiment. Processes of S102 to S106 can be the same as the processes S74 to S78 of FIG. 18 respectively, so explanations of that will be omitted.

The bonus game lottery process of S101 will be described. The bonus game lottery process of S101 in FIG. 22 is basically same as the base game lottery process in FIG. 19, so explanation will be omitted.

In this embodiment, an image effect in which a character stops spinning video reel 5D may be conducted on the lower image display panel 6 the same as FIG. 14.

According to this embodiment, if the bonus trigger is realized, the bonus game will be executed with the bonus reel. Here, the bonus reel has only “WIN” symbol. In the bonus game, if the number of displayed “WIN” symbols on the window displays 10A, 10B, and 10C are the predetermined number or above, the second reel will be spin and stopped. And then, the payout will be provided based on the stopped symbol on the window display 10D. Also, according to this embodiment, in the bonus game, the player can easily recognize the game result by only counting the “WIN” symbols.

Aspects of the present invention may be applied in the field where symbols are displayed on the display device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
first reels, each of the first reels having one or more first symbols, the one or more first symbols including a scatter symbol, each of the first symbols making up a combination;
second reels, each of the second reel having second symbols, each of the second symbols indicating an outcome respectively;
a value input device;
a display; and
a game controller programmed to:
(a) select one second reel among the second reels based on bet value input by the value input device in a unit game,
(b) spin and then stop each of the first reels on the display, and
(c) spin and then stop the selected second reel on the display,
wherein the first symbols are repositioned based on that each of the first reels is spin and stopped on the display, and
wherein the second symbol is repositioned based on that the second reel is spin and stopped on the display.

2. The gaming machine according to claim 1, wherein the game controller is programmed to provide the outcome corresponding to the repositioned second symbol when the repositioned first symbols include the scatter symbols with a predetermined number or more.

3. The gaming machine according to claim 1, wherein the outcome includes an award or a bonus game.

4. A gaming machine comprising:
first reels, each of the first reels having one or more first symbols, the one or more first symbols including a scatter symbol, each of the first symbols making up a combination;
second reels, each of the second reels corresponding to a rank respectively, each of the second reel having second symbols, each of the second symbols indicating an outcome respectively;
a value input device;
a display; and
a game controller programmed to:
(a) select one second reel among the second reels based on bet value input by the value input device in a unit game,
(b) spin and then stop each of the first reels on the display,
(c) spin and then stop the selected second reel on the display, and
(d) provide the outcome corresponding to the repositioned second symbol when the repositioned first symbols include the scatter symbols with a predetermined number or more,
wherein the first symbols are repositioned based on that each of the first reels is spin and stopped on the display,
wherein the second symbol is repositioned based on that the second reel is spin and stopped on the display, and
wherein the outcome includes an award or a bonus game.

5. A gaming machine comprising:
first reels, each of the first reel having first symbols, the first symbols are the same, each of the first symbols making up a combination;
second reels, each of the second reel having second symbols, each of the second symbols indicating an outcome respectively;
a value input device;
a display; and
a game controller programmed to:
(a) select one second reel among the second reels based on bet value input by the value input device in a unit game,
(b) spin and then stop each of the first reels on the display, and
(c) spin and then stop the selected second reel on the display,
wherein the first symbols are repositioned based on that each of the first reels is spin and stopped on the display, and
wherein the second symbol is repositioned based on that the second reel is spin and stopped on the display.

6. A gaming method comprising:
selecting one second reel among plural second reels based on a bet value, each of the second symbols indicating an outcome respectively, the bet value being input by a user;
spinning and then stopping first reels on a display in a unit game, each of the first reels having one or more first symbols, the one or more first symbols including a scatter symbol, each of the first symbols making up a combination;
spinning and then stopping the selected second reel on the display in the unit game;
wherein the first symbols are repositioned based on that each of the first reels is spin and stopped on the display,
wherein the second symbol is repositioned based on that the second reel is spin and stopped on the display, and
wherein the unit game is repeatedly executed.

7. The gaming method according to claim 6, further comprising:
providing the outcome corresponding to the repositioned second symbol when the repositioned first symbols include the scatter symbols with a predetermined number or more.

8. The gaming method according to claim 6, wherein the outcome includes an award or a bonus game.

9. A gaming method comprising:
selecting one second reel among plural second reels based on a bet value, each of the second symbols indicating an outcome respectively, the bet value being input by a user;
spinning and then stopping first reels on a display in a unit game, each of the first reels having one or more first symbols, the one or more first symbols including a scatter symbol, each of the first symbols making up a combination;
spinning and then stopping the selected second reel on the display in the unit game;
providing the outcome corresponding to the repositioned second symbol when the repositioned first symbols include the scatter symbols with a predetermined number or more;
wherein the first symbols are repositioned based on that each of the first reels is spin and stopped on the display,
wherein the second symbol is repositioned based on that the second reel is spin and stopped on the display,
wherein the outcome includes an award or a bonus game, and
wherein the unit game is repeatedly executed.
